(19) United States
(12) Patent Application Publication
(10) Pub. No.: US 2022/0273405 A1
(43) Pub. Date: Sep. 1, 2022

(54) DUAL-WATER-TANK WATER FLOSSER

(71) Applicant: Xiamen Solex High-Tech Industries Co., Ltd., Xiamen (CN)

(72) Inventors: Cen YANG, Xiamen (CN); Shuixiu Xie, Xiamen (CN); Tingke Liu, Xiamen (CN); Mingfu Zhang, Xiamen (CN)

(21) Appl. No.: 17/749,027

(22) Filed: May 19, 2022

Related U.S. Application Data
(63) Continuation of application No. PCT/CN2020/134930, filed on Dec. 9, 2020.

(30) Foreign Application Priority Data
Dec. 10, 2019 (CN) 201911258327.8
Jul. 27, 2020 (CN) 202010731237.2

(51) Int. Cl. A61C 17/02

(52) U.S. Cl. CPC A61C 17/0202

(57) ABSTRACT

A dual-water-tank water flosser comprises a body, a tooth-rinsing component, a first water tank, a second water tank, a first water pipe respectively connected to the first water tank and a water inlet, a second water pipe respectively connected to the second water tank and the water inlet, and a switching element. The tooth-rinsing component is installed in the body and has the water inlet and a water outlet. The first water tank and the second water tank are installed on the body. The switching element is movably disposed on the body and has two gear positions, one of the two gear positions corresponds to the switching element moving to close the first water pipe while simultaneously opening the second water pipe, and the other one of the two gear positions corresponds to the switching element moving to open the first water pipe while simultaneously closing the second water pipe.

### RELATED APPLICATIONS

This application is a continuation of and claims priority to International patent application number PCT/CN2020/134930, filed on Dec. 9, 2020, which claims priority to Chinese patent application number 201911258327.8, filed on Dec. 10, 2019, and Chinese patent application number 202010731237.2, filed on Jul. 27, 2020. International patent application number PCT/CN2020/134930, Chinese patent application number 201911258327.8, and Chinese patent application number 202010731237.2 are incorporated herein by reference.

### FIELD OF THE DISCLOSURE

The present disclosure relates to a dual-water-tank water flosser.

### BACKGROUND OF THE DISCLOSURE

With the improvement of people's living standards, water flossers have become a common oral teeth cleaning appliance in recent years. Using a mechanical principle of a water pump, a water flow can be driven by external water pressure or pressure generated by an electric motor to push a jet to remove dirt on teeth and small debris between the teeth and remove small food debris, harmful bacteria, stains, and tartar, which adhere to the teeth and gums, to achieve improve oral health care, so as to provide better caring effect on a basis of brushing teeth.

The existing water flossers comprise a tooth-rinsing component, a water nozzle, and a water tank. Each of the water tank and the water nozzle are connected to the tooth-rinsing component. The water tank is a single tank and can only store one kind of liquid. When a user needs to use two liquids interchangeably, the existing water flossers cannot realize a function of interchangeably using the two liquids.

### BRIEF SUMMARY OF THE DISCLOSURE

The present disclosure provides a dual-water-tank water flosser to solve the deficiencies in the background.

In order to solve the technical problem, a first technical solution of the present disclosure is as follows.

A dual-water-tank water flosser comprises a body, a tooth-rinsing component, a first water tank, a second water tank, a first water pipe, a second water pipe, and a switching element. The tooth-rinsing component is disposed in the body and has a water inlet and a water outlet. The first water tank and the second water tank are disposed on the body. A first end of the first water pipe is in communication with the first water tank, and a second end of the first water pipe is in communication with the water inlet of the tooth-rinsing component. A first end of the second water pipe is in communication with the second water tank, and a second end of the second water pipe is in communication with the water inlet of the tooth-rinsing component. The switching element is movably disposed on the body and has two gear positions. When the switching element is in a first gear position of the two gear positions, the switching element closes the first water pipe while simultaneously opening the second water pipe, and when the switching element is in a second gear position of the two gear positions, the switching element opens the first water pipe while simultaneously closing the second water pipe.

In a preferred embodiment, when the switching element is in the first gear position, the switching element closes the first water pipe through squeezing the first water pipe and simultaneously releases the second water pipe to open the second water pipe. When the switching element is in the second gear position, the switching element opens the first water pipe through releasing the first water pipe and simultaneously squeezes the second water pipe to close the second water pipe.

In a preferred embodiment, the switching element comprises a push-sliding button portion, a first squeezing portion, and a second squeezing portion, and the first squeezing portion and the second squeezing portion are fixedly connected to the push-sliding button portion. The first squeezing portion is configured to match and squeeze the first water pipe, and the second squeezing portion is configured to match and squeeze the second water pipe.

In a preferred embodiment, the first water pipe and the second water pipe are respectively located on two sides of the switching element, and the first squeezing portion and the second squeezing portion are spaced apart from and misaligned with each other. The first squeezing portion and the first water pipe are located on a first side of the two sides of the switching element, and the second squeezing portion and the second water pipe are located on a second side of the two sides of the switching element.

In a preferred embodiment, the body comprises a fixed seat having a receiving groove, and the receiving groove comprises a first squeezing matching portion and a second squeezing matching portion spaced apart from each other. Each of the first water pipe and the second water pipe passes through the receiving groove, and the switching element is movably disposed in the receiving groove. The first water pipe is located between the first squeezing portion and the first squeezing matching portion, and the second water pipe is located between the second squeezing portion and the second squeezing matching portion.

In a preferred embodiment, the first squeezing matching portion and the second squeezing matching portion are misaligned with each other along a length direction of the receiving groove, and the switching element is configured to move along the length direction of the receiving groove.

In a preferred embodiment, the first squeezing portion and the second squeezing portion, are a dual-cam structure, and the first squeezing portion and the second squeezing portion are misalignedly disposed on two sides of the push-sliding button portion along an up-and-down direction. A cross section of the push-sliding button portion is elliptical, and an outer surface of the first squeezing portion and an outer surface of the second squeezing portion are arc-shaped. When the push-sliding button portion is pushed to slide upward and downward to switch, the outer surface of the first squeezing portion and the outer surface of the second squeezing portion are configured to be respectively in sliding contact with the first water pipe and the second water pipe.

In a preferred embodiment, the dual-water-tank water flosser comprises a water inlet connector. The water inlet connector is disposed in the body and has a first inlet port, a second inlet port and an outlet port. The first inlet port is connected to the second end of the first water pipe, the second inlet port is connected to the second end of the second water pipe, and the outlet port is connected to the water inlet of the tooth-rinsing component.

In a preferred embodiment, the first water tank and the second water tank are fixedly connected to a rear side of the body, the first water tank comprises a first water replenishing port, and the second water tank comprises a second water replenishing port.

In a preferred embodiment, the first water tank and the second water tank are integrally formed, and the first water tank and the second water tank are located at a hand-held portion of the body. A cross-section of the first water tank and a cross-section of the second water tank respectively comprise a duckbill-shaped portion, and the duckbill-shaped portion of the second water tank is wrapped outside of a bottom of the first water tank. The duckbill-shaped portion of the second water tank is higher than the bottom of the first water tank.

In a preferred embodiment, the switching element is a gasket structure, and the gasket structure is located between the first inlet port and the second inlet port. The switching element is configured to act to enable the gasket structure to seal the first inlet port while the first water pipe is closed and the second water pipe is opened, and the switching element is configured to act to enable the gasket structure to seal the second inlet port while the first water pipe is opened and the second water pipe is closed.

In a preferred embodiment, the dual-water-tank water flosser comprises a water nozzle, and the water nozzle is in communication with the water outlet of the tooth-rinsing component.

Compared with the existing techniques, the technical solution has the following advantages.

1. Since the water flosser comprises two water tanks, the tooth-rinsing component is switched to one of the two water tanks through the switching element, and the two water tanks can be filled with different liquids to meet the different needs of users. Alternatively, the two water tanks can be filled with the same liquid to expand the capacity of water reservoir.

2. The first squeezing portion cooperates with the first squeeze matching portion to squeeze the first water pipe to close the first water pipe, and the second squeeze portion cooperates with the second squeezing matching portion to squeeze the second water pipe to close the second water pipe. This switching structure is a novel structure and provides convenient switching.

### BRIEF DESCRIPTION OF THE DRAWINGS

FIG. 1 illustrates a front view of a dual-water-tank water flosser in a preferred embodiment of the present disclosure.

FIG. 2 illustrates a side view of the dual-water-tank water flosser in a preferred embodiment of the present disclosure.

FIG. 3 illustrates an exploded view of the dual-water-tank water flosser in a preferred embodiment of the present disclosure.

FIG. 4 illustrates a first cross-sectional view of the dual-water-tank water flosser in a preferred embodiment of the present disclosure.

FIG. 5 illustrates a second cross-sectional view of the dual-water-tank water flosser in a preferred embodiment of the present disclosure.

FIG. 6 illustrates a partial cross-sectional view of the dual-water-tank water flosser in a preferred embodiment of the present disclosure, when a first water pipe is closed and a second water pipe is opened.

FIG. 7 illustrates a partial cross-sectional view of the dual-water-tank water flosser in a preferred embodiment of the present disclosure, when the first water pipe is opened and the second water pipe is closed.

### DETAILED DESCRIPTION OF THE EMBODIMENTS

The present disclosure will be further described below in combination with the accompanying drawings and embodiments.

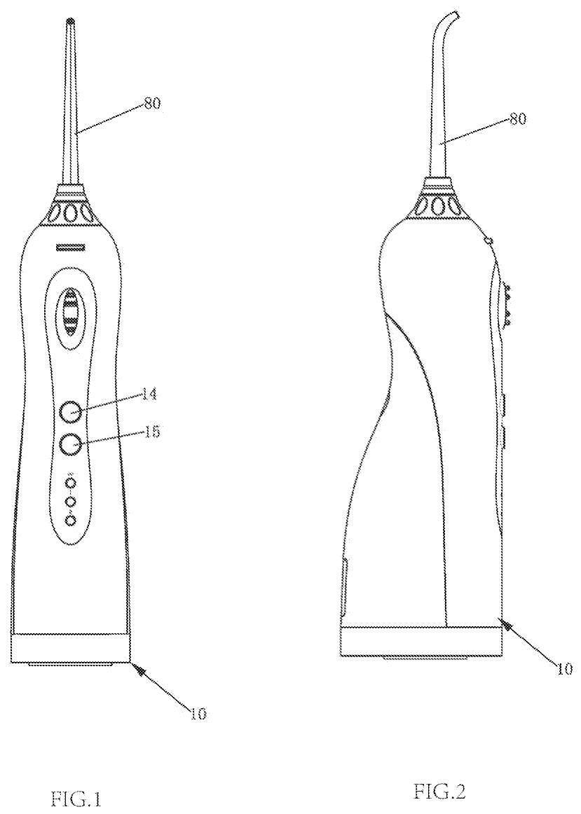

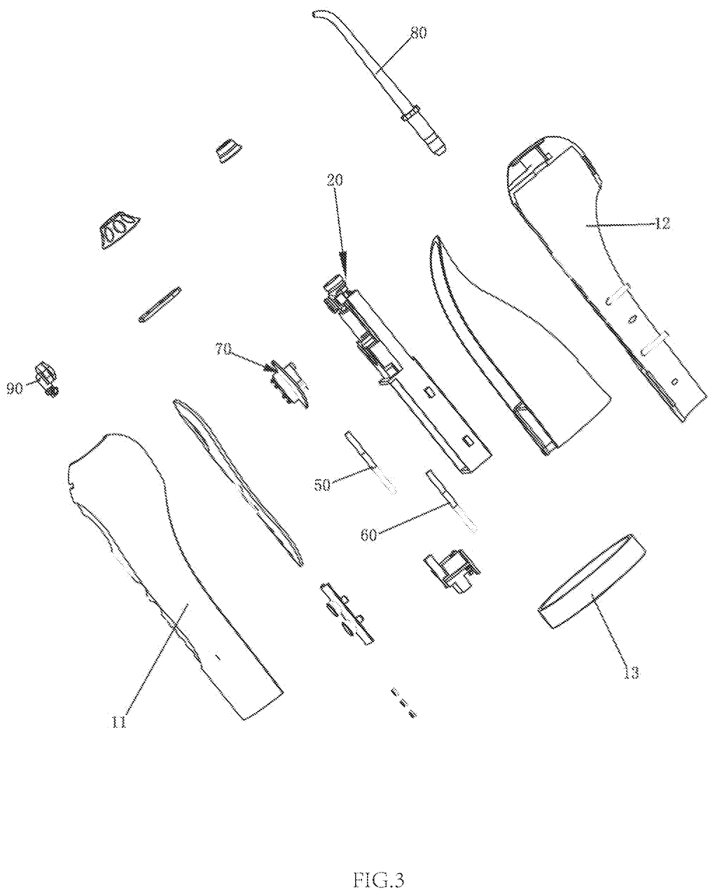

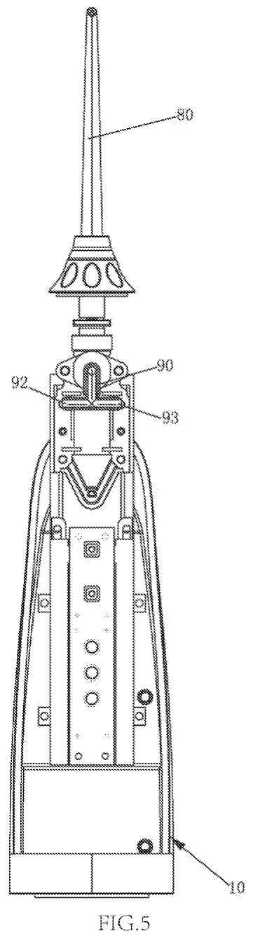

Referring to FIGS. 1 to 7, a preferred embodiment of a dual-water-tank water flosser is provided. The dual-water-tank water flosser comprises a body 10, a tooth-rinsing component 20, a first water tank 30, a second water tank 40, a first water pipe 50, a second water pipe 60, a switching element 70, and a water nozzle 80.

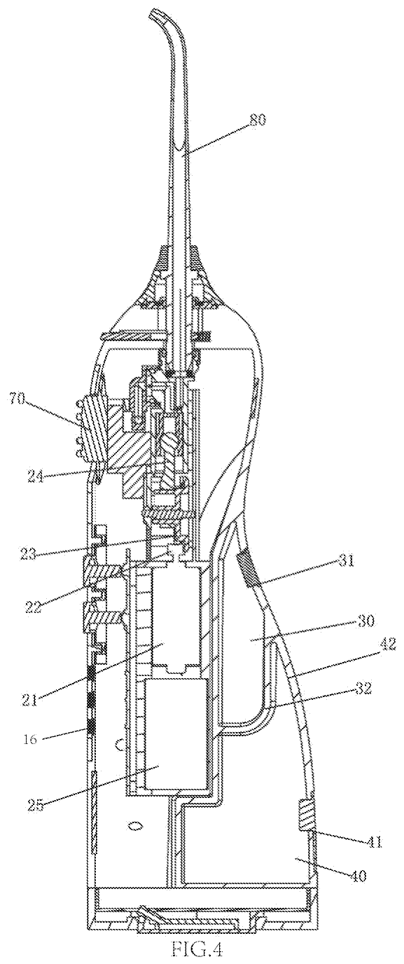

Referring to FIGS. 3 and 4, the body 10 comprises a front body 11, a rear body 12, and a base 13. The front body 11 is fixedly connected to the rear body 12, and the base 13 is fixedly connected to a lower end of the front body 11 and a lower end of the rear body 12. A front of the body 10 is disposed with a switching button 14, an adjusting button 15, an indicator light 16, and other components.

The tooth-rinsing component 20 is installed in the body 10 and comprises a water inlet and a water outlet. Referring to FIG. 4, the tooth-rinsing component 20 comprises a motor 21, a gear 22, an eccentric wheel 23, and a piston 24. A rotation of the motor 21 drives the gear 22 to rotate, the gear 22 drives the eccentric wheel 23 to rotate, and the eccentric wheel 23 drives the piston 24 to reciprocate to achieve water pumping. The water nozzle 80 is in communication with the water outlet of the tooth-rinsing component 20, and the water nozzle 80 is detachably connected to the body 10. Preferably, the tooth-rinsing component 20 can also be disposed with a replaceable battery 25. The replaceable battery 25 is in the existing technology and will not be repeated here.

Each of the first water tank 30 and the second water tank 40 are installed on the body 10. In this embodiment, the first water tank 30 and the second water tank 40 are integrally formed and fixedly connected to a rear side of the body 10. The first water tank 30 comprises a first water replenishing port 31, and the second water tank 40 comprises a second water replenishing port 41. Referring to FIG. 4, the first water tank 30 and the second water tank 40 are separated by a partition 32. The first water tank 30 is located above the second water tank 40, and a volume of the first water tank 30 is smaller than a volume of the second water tank 40.

In this embodiment, the first water tank 30 and the second water tank 40, which are integrally formed, are located at a hand-held portion of the body 10. A cross-section of the first water tank 30 and a cross-section of the second water tank 40 respectively comprise a duckbill-shaped portion. The duckbill-shaped portion 42 of the second water tank 40 is wrapped outside of a bottom of the first water tank 30, and the duckbill-shaped portion 42 of the second water tank 40 is higher than the bottom of the first water tank 30.

A first end of the first water pipe 50 is in communication with the first water tank 30, and a second end of the first water pipe 50 is in communication with the water inlet of the tooth-rinsing component 20. A first end of the second water pipe 60 is in communication with the second water tank 40, and a second end of the second water pipe 60 is in communication with the water inlet of the tooth-rinsing component 20. Specifically, the dual-water-tank water flosser further comprises a water inlet connector 90, which is installed in the body 10 and comprises a first inlet port 91, a second inlet port 92, and an outlet port 93. The first inlet port 91 is connected to the second end of the first water pipe 50, the second inlet port 92 is connected to the second end of the second water pipe 60, and the outlet port 93 is connected to the water inlet of the tooth-rinsing component 20.

The switching element 70 is movably disposed on the body 10 and has two gear positions. In a first gear position of the two gear positions, the switching element 70 closes the first water pipe 50 while simultaneously opening the second water pipe 60. In a second gear position of the two gear positions, the switching element 70 opens the first water pipe 50 while simultaneously closing the second water pipe 60.

In this embodiment, when the switching element 70 is in the first gear position, the switching element 70 closes the first water pipe 50 through squeezing the first water pipe 50 and simultaneously releases the second water pipe 60 to open the second water pipe 60. When the switching element 70 is in the second gear position, the switching element 70 opens the first water pipe 50 through releasing the first water pipe 50 and simultaneously squeezes the second water pipe 60 to close the second water pipe 60.

In this embodiment, the switching element 70 comprises a push-sliding button portion 71, a first squeezing portion 72, and a second squeezing portion 73, and the first squeezing portion 72 and the second squeezing portion 73 are fixedly connected to the push-sliding button portion 71. The first squeezing portion 72 is configured to match and squeeze the first water pipe 50, and the second squeezing portion 73 is configured to match and squeeze the second water pipe 60. For example, the first water pipe 50 and the second water pipe 60 can be set in a form of a combination of a flexible portion and a rigid portion. The rigid portion of the first water pipe 50 can abut the body 10, and the rigid portion of the second water pipe 60 can abut the body 10. The flexible portion of the first water pipe 50 and the flexible portion of the second water pipe 60 are opposite to each other, and the switching element 70 is disposed between the first water pipe 50 and the second water pipe 60, so that the first squeezing portion 72 can match and squeeze the flexible portion of the first water pipe 50 and the second squeezing portion 73 can match and squeeze the flexible portion of the second water pipe 60.

In this embodiment, the first water pipe 50 and the second water pipe 60 are respectively located on two sides of the switching element 70, and the first squeezing portion 72 and the second squeezing portion 73 are spaced apart from and misaligned with each other. The first squeezing portion 72 and the first water pipe 50 are located on a first side of the two sides of the switching element 70, and the second squeezing portion 73 and the second water pipe 60 are located on a second side of the two sides of the switching element 70.

In this embodiment, the body 10 comprises a fixed seat 17 having a receiving groove 171 extending along an up-and-down direction. The receiving groove 171 comprises a first squeezing matching portion 172 and a second squeezing matching portion 173 spaced apart from each other along a left-and-right direction. Each of the first water pipe 50 and the second water pipe 60 pass upward through the receiving groove 171. The switching element 70 is movably disposed in the receiving groove 171, the first water pipe 50 is located between the first squeezing portion 72 and the first squeezing matching portion 172, and the second water pipe 60 is located between the second squeezing portion 73 and the second squeezing matching portion 173. According to needs, dispensing with the first squeezing matching portion 172 and the second squeezing matching portion 173, the first squeezing portion 72 and the second squeezing portion 73 are directly, respectively matched with a groove wall of the receiving groove 171.

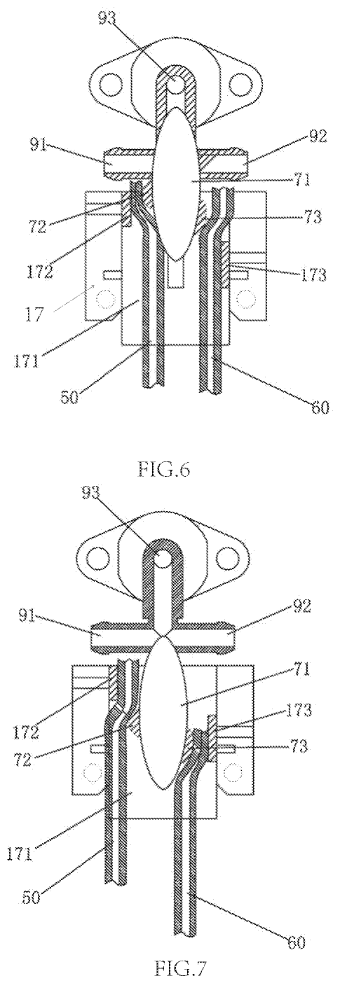

In this embodiment, the first squeezing matching portion 172 and the second squeezing matching portion 173 are misaligned with each other along a length direction of the receiving groove 171, and the switching element 70 can move along the length direction of the receiving groove 171. Referring FIG. 6, each of the first squeezing matching portion 172 and the second squeezing matching portion 173 are rectangular.

Referring to FIGS. 1 to 7, in this embodiment, the first squeezing portion 72 and the second squeezing portion 73, which are fixedly connected to the push-sliding button portion 71, are a dual-cam structure, and the first squeezing portion 72 and the second squeezing portion 73 are misalignedly disposed on two sides of the push-sliding button portion 71 along the up-and-down direction. A cross section of the push-sliding button portion 71 is elliptical, and an outer surface of the first squeezing portion 72 and an outer surface of the second squeezing portion 73 are arc-shaped. The push-sliding button portion 71 protrudes from the front of the body 10. When the push-sliding button portion 71 is pushed to slide up and down to switch, the outer surface of the first squeezing portion 72 and the outer surface of the second squeezing portion 73 are configured to be respectively in sliding contact with the first water pipe 50 and the second water pipe 60.

The principle of waterway switching of the dual-water-tank water flosser is as follows:

Referring to FIG. 6, the push-sliding button portion 71 is pushed upward to drive the first squeezing portion 72 and the second squeezing portion 73 to move upward at the same time. During the upward movement, the first squeezing portion 72 and the first squeezing matching portion 172 cooperate with each other to squeeze the first water pipe 50 until the first water pipe 50 is completely closed. At this time, a distance between the second squeezing portion 73 and the second squeezing matching portion 173 increases to enable the second water pipe 60 to be opened. A liquid in the second water tank 40 flows through the second water pipe 60, enters the tooth-rinsing component 20, and then flows out from the water nozzle 80.

Referring to FIG. 7, the push-sliding button portion 71 is pushed downward to drive the first squeezing portion 72 and the second squeezing portion 73 to move downward at the same time. During the downward movement, a distance between the first squeezing portion 72 and the first squeezing matching portion 172 increases to enable the first water pipe 50 to be opened. At this time, the second squeezing portion 73 and the second squeezing matching portion 173 cooperate with each other to squeeze the second water pipe 60 until the second water pipe 60 is closed. A liquid in the first water tank 30 flows through the first water pipe 50, enters the tooth-rinsing component 20, and then flows out from the water nozzle 80.

Another embodiment of the present disclosure is different from the previous embodiment in that the switching element 70 can adopt a gasket structure. The gasket structure is located between the first inlet port 91 and the second inlet port 92, and the switching element 70 acts to enable the gasket structure to seal the first inlet port 91, and at this time, the first water pipe 50 is closed and the second water pipe 60 is opened. The switching element 70 acts to enable the gasket structure to seal the second inlet port 92, and at this time, the first water pipe 50 is opened and the second water pipe 60 is closed.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. A dual-water-tank water flosser, comprising:
a body,
a tooth-rinsing component,
a first water tank,
a second water tank,
a first water pipe,
a second water pipe, and
a switching element, wherein:
the tooth-rinsing component is disposed in the body and has a water inlet and a water outlet,
the first water tank and the second water tank are disposed on the body,
a first end of the first water pipe is in communication with the first water tank,
a second end of the first water pipe is in communication with the water inlet of the tooth-rinsing component,
a first end of the second water pipe is in communication with the second water tank,
a second end of the second water pipe is in communication with the water inlet of the tooth-rinsing component,
the switching element is movably disposed on the body and has two gear positions,
when the switching element is in a first gear position of the two gear positions, the switching element closes the first water pipe while simultaneously opening the second water pipe, and
when the switching element is in a second gear position of the two gear positions, the switching element opens the first water pipe while simultaneously closing the second water pipe.

2. The dual-water-tank water flosser according to claim 1, wherein:
when the switching element is in the first gear position:
the switching element closes the first water pipe through squeezing the first water pipe and simultaneously releases the second water pipe to open the second water pipe, and
when the switching element is in the second gear position:
the switching element opens the first water pipe through releasing the first water pipe and simultaneously squeezes the second water pipe to close the second water pipe.

3. The dual-water-tank water flosser according to claim 2, wherein:
the switching element comprises a push-sliding button portion, a first squeezing portion, and a second squeezing portion,
the first squeezing portion and the second squeezing portion are fixedly connected to the push-sliding button portion,
the first squeezing portion is configured to match and squeeze the first water pipe, and
the second squeezing portion is configured to match and squeeze the second water pipe.

4. The dual-water-tank water flosser according to claim 3, wherein:
the first water pipe and the second water pipe are respectively located on two sides of the switching element,
the first squeezing portion and the second squeezing portion are spaced apart from and misaligned with each other,
the first squeezing portion and the first water pipe are located on a first side of the two sides of the switching element, and
the second squeezing portion and the second water pipe are located on a second side of the two sides of the switching element.

5. The dual-water-tank water flosser according to claim 4, wherein:
the body comprises a fixed seat having a receiving groove,
the receiving groove comprises a first squeezing matching portion and a second squeezing matching portion spaced apart from each other,
each of the first water pipe and the second water pipe passes through the receiving groove,
the switching element is movably disposed in the receiving groove,
the first water pipe is located between the first squeezing portion and the first squeezing matching portion, and
the second water pipe is located between the second squeezing portion and the second squeezing matching portion.

6. The dual-water-tank water flosser according to claim 5, wherein:
the first squeezing matching portion and the second squeezing matching portion are misaligned with each other along a length direction of the receiving groove, and
the switching element is configured to move along the length direction of the receiving groove.

7. The dual-water-tank water flosser according to claim 4, wherein:
the first squeezing portion and the second squeezing portion are a dual-cam structure,
the first squeezing portion and the second squeezing portion are misalignedly disposed on two sides of the push-sliding button portion along an up-and-down direction,
a cross section of the push-sliding button portion is elliptical,
an outer surface of the first squeezing portion and an outer surface of the second squeezing portion are arc-shaped, and
when the push-sliding button portion is pushed to slide upward and downward to switch, the outer surface of the first squeezing portion and the outer surface of the second squeezing portion are configured to be respectively in sliding contact with the first water pipe and the second water pipe.

8. The dual-water-tank water flosser according to claim 1, comprising:
a water inlet connector, wherein:
the water inlet connector is disposed in the body and has a first inlet port, a second inlet port, and an outlet port,
the first inlet port is connected to the second end of the first water pipe,
the second inlet port is connected to the second end of the second water pipe, and
the outlet port is connected to the water inlet of the tooth-rinsing component.

9. The dual-water-tank water flosser according to claim 1, wherein:
the first water tank and the second water tank are fixedly connected to a rear side of the body,
the first water tank comprises a first water replenishing port, and
the second water tank comprises a second water replenishing port.

10. The dual-water-tank water flosser according to claim 9, wherein:
the first water tank and the second water tank are integrally formed,
the first water tank and the second water tank are located at a hand-held portion of the body,
a cross-section of the first water tank and a cross-section of the second water tank respectively comprise a duckbill-shaped portion,
the duckbill-shaped portion of the second water tank is wrapped outside of a bottom of the first water tank, and
the duckbill-shaped portion of the second water tank is higher than the bottom of the first water tank.

11. The dual-water-tank water flosser according to claim 1, wherein:
the switching element is a gasket structure,
the gasket structure is located between a first inlet port and a second inlet port,
the switching element is configured to act to enable the gasket structure to seal the first inlet port while the first water pipe is closed and the second water pipe is opened, and
the switching element is configured to act to enable the gasket structure to seal the second inlet port while the first water pipe is opened and the second water pipe is closed.

12. The dual-water-tank water flosser according to claim 1, comprising:
a water nozzle, wherein:
the water nozzle is in communication with the water outlet of the tooth-rinsing component.

13. The dual-water-tank water flosser according to claim 9, wherein:
the switching element is a gasket structure,
the gasket structure is located between a first inlet port and a second inlet port,
the switching element is configured to act to enable the gasket structure to seal the first inlet port while the first water pipe is closed and the second water pipe is opened, and
the switching element is configured to act to enable the gasket structure to seal the second inlet port while the first water pipe is opened and the second water pipe is closed.
